(19) United States
(12) Patent Application Publication
(10) Pub. No.: US 2021/0139704 A1
(43) Pub. Date: May 13, 2021

(54) METHOD FOR PRODUCING PARAFFIN WAX

(71) Applicant: ENEOS Corporation, Tokyo (JP)

(72) Inventors: Kosuke HARADA, Tokyo (JP); Satoshi KIDOGUCHI, Tokyo (JP); Yu YOSHIMURA, Tokyo (JP); Toshiyuki IWASAKI, Tokyo (JP)

(73) Assignee: ENEOS Corporation, Tokyo (JP)

(21) Appl. No.: 17/091,412

(22) Filed: Nov. 6, 2020

(30) Foreign Application Priority Data
Nov. 12, 2019 (JP) 2019-204748

(51) Int. Cl. C08L 91/06; B01D 11/02

(52) U.S. Cl. CPC C08L 91/06; B01D 11/0288

(57) ABSTRACT

Disclosed is a method for producing a paraffin wax, the method including a step of mixing an unrefined wax containing normal paraffin with a solvent of dipole term (δp) is 4 to 8 and of hydrogen bonding term (δh) is 3 to 10 of the Hansen Solubility Parameters, and obtaining a mixed liquid; and a step of separating a solid material from the mixed liquid and obtaining a paraffin wax in which the normal paraffin concentration is higher.

### TECHNICAL FIELD

The present invention relates to a method for producing a paraffin wax.

### BACKGROUND

A method for dewaxing a raw material oil of a lubricating oil by using a solvent such as methyl ethyl ketone (MEK) or toluene is known.

Japanese Unexamined Patent Publication No. S55-123687

A paraffin wax can be obtained by filtering and collecting a solid material precipitated by the above-described method. However, in the above-described method, since a large quantity of a solvent is used and it is necessary to precipitate out wax at a low temperature, it is not preferable in view of productivity. Furthermore, since MEK or toluene is used, this method is not preferable even from an environmental viewpoint.

### SUMMARY

The present invention was achieved in view of the above-described circumstances, and it is an object of the invention to provide a novel production method for a paraffin wax.

The present invention relates to a method for producing a paraffin wax, the method comprising a step of mixing an unrefined wax including normal paraffin with a solvent of dipole term (δp) is 4 to 8 and of hydrogen bonding term (δh) is 3 to 10 of the Hansen solubility parameters (HSP), and obtaining a mixed liquid; and a step of separating a solid material from the mixed liquid and obtaining a paraffin wax in which the normal paraffin concentration is higher. According to the present invention, an oil fraction and the like can be efficiently selectively removed from a wax.

According to an embodiment, the solvent may not include a poisonous substance or a deleterious substance, which are specified by the Poisonous and Deleterious Substances Control Law in Japan. According to the present invention, washing of a paraffin wax can be carried out only with a highly safe solvent.

According to an embodiment, a heat of evaporation of the solvent may be 500 kJ/L or less.

According to an embodiment, the unrefined wax and the solvent may be mixed such that a mass ratio of the solvent with respect to the unrefined wax (mass of the solvent/mass of the unrefined wax) is 5/1 to 1/2.

According to an embodiment, a separation factor calculated by the following formula may be 5 or greater:

(Cw/(1−Cw))/(C0/(1−C0))

wherein Cw and C0 represent the normal paraffin concentration in the paraffin wax (refined wax) and the normal paraffin concentration in the unrefined wax, respectively.

According to an embodiment, the above-described production method may further comprise a step of selecting a solvent of dipole term (δp) is 4 to 8 and of hydrogen bonding term (δh) is 3 to 10 of the HSP.

According to the present invention, a novel production method for a paraffin wax can be provided. The production method of the present invention has the following three features in combination.

Excellent washability: The normal paraffin concentration in a wax increases as a result of a washing operation. For example, the separation factor that will be described below can be adjusted to 5 or greater.

Excellent selectivity: The dissolution of normal paraffin in an unrefined wax into a solvent can be sufficiently reduced. For example, the normal paraffin recovery rate that will be described below can be adjusted to 85% or higher.

Low toxicity: By paying attention to the HSP, it is possible to design a solvent without using poisonous and deleterious substances that are specified by the Poisonous and Deleterious Substances Control Law in Japan.

### DETAILED DESCRIPTION

Hereinafter, suitable embodiments of the present invention will be described.

The method for producing a paraffin wax according to the present embodiment comprises a step of mixing an unrefined wax including normal paraffin with a predetermined solvent and obtaining a mixed liquid (mixing step); and a step of separating a solid material from the mixed liquid and obtaining a paraffin wax in which the normal paraffin concentration is higher (separation step). The predetermined solvent is a solvent of dipole term (δp) is 4 to 8 and of hydrogen bonding term (δh) is 3 to 10 of the HSP. Here, the unrefined wax means a wax that has not been subjected to the washing operation (the above-described mixing step and separation step) according to the present application. Furthermore, the paraffin wax means a wax that contains linear paraffin-based hydrocarbons (normal paraffin) as a main component and is solid at normal temperature.

With regard to the method for producing a paraffin wax as described above, it is important to prepare in advance a solvent having specific HSP. Therefore, the above-described method for producing a paraffin wax may further comprise a step of selecting a solvent of dipole term (δp) is 4 to 8 and of hydrogen bonding term (δh) is 3 to 10 of the HSP (solvent selection step).

From the viewpoint of refining an unrefined wax including normal paraffin by washing the unrefined wax with a predetermined solvent, the method for producing a paraffin wax can be considered as a method for refining a paraffin wax. Washing means separating a solid material that has been precipitated out by mixing an object material and a solvent, and selectively removing materials other than a target substance from the object material. Refinement involves processing an object material, which is a crude product, and thereby finishing the crude product into a product having superior quality.

(Mixing Step)

An unrefined wax contains normal paraffin. Here, normal paraffin refers to linear saturated hydrocarbons. The content of the normal paraffin in the unrefined wax is not particularly limited; however, from the viewpoint of the refining efficiency, for example, the content may be 10% by volume or more, is preferably 30% by volume or more, and more preferably 50% by volume or more. This content may be, for example, 95% by volume or less, is preferably 90% by volume or less, and more preferably 85% by volume or less. The normal paraffin content can be quantitatively determined by gas chromatography, which is provided with a non-polar column and a hydrogen flame ionization detector (FID) and is operated with a predetermined temperature program. Gas chromatography is an analytical technique of separating and quantitatively analyzing various compositions by utilizing the physical properties (boiling point, polarity, and the like) of the various compositions in a sample.

With regard to the unrefined wax, the average number of carbon atoms of the normal paraffin may be 10 or more and is preferably 15 or more, and more preferably 20 or more. The average number of carbon atoms of the normal paraffin may be 50 or less and is preferably 40 or less. The average number of carbon atoms is calculated by using a weighted average of the normal paraffin concentration (% by mass) of various number of carbon atoms determined by a gas chromatography apparatus.

With regard to the unrefined wax, the content ratio of normal paraffin having 20 or more carbon atoms is not particularly limited; however, for example, the content ratio may be 10% by volume or more, is preferably 30% by volume or more, and more preferably 50% by volume or more. With regard to the unrefined wax, the content ratio of normal paraffin having 25 or more carbon atoms may be, for example, 5% by volume or more and is preferably 15% by volume or more, and more preferably 25% by volume or more.

The unrefined wax further contains other hydrocarbon compounds other than normal paraffin. Examples of the other hydrocarbon compounds include isoparaffin, cycloparaffin, and aromatic fractions. By refining the unrefined wax and thereby removing these compounds, for example, a paraffin wax that can be suitably used in use applications for lubricant oil production and the like can be produced.

The method for obtaining an unrefined wax is not particularly limited; however, for example, a method of subjecting mineral oil to pressure filtration using filter pressing, a method of mixing mineral oil with a solvent and then filtering the mixture, and the like may be mentioned.

As the unrefined wax, a solid material that is precipitated out by adding a low-temperature fluidity improver to a hydrocarbon oil and then leaving this under low temperature conditions can also be used. In the following description, this method will be briefly described.

The method for producing an unrefined wax comprises, for example, a precipitation step of adding a low-temperature fluidity improver to a hydrocarbon oil of 10 vol % distillation temperature is 300° C. or higher, and precipitating a solid material under the temperature conditions of 5° C. to 40° C.; and a separation step of collecting the solid material as a non-transmissive fraction by a solid-liquid separation method.

In the precipitation step, a low-temperature fluidity improver is added to a hydrocarbon oil, thereby a mixed oil is prepared, and a solid material is precipitated out under the temperature conditions of 5° C. to 40° C. The 10 vol % distillation temperature of the hydrocarbon oil is 300° C. or higher, and preferably 320° C. or higher. The 90 vol % distillation temperature of the hydrocarbon oil is preferably 480° C. or lower, and more preferably 460° C. or lower. The distillation temperature of the hydrocarbon oil can be determined by Japanese Industrial Standards (HS) K2254 (Petroleum products-Determination of distillation characteristics). The hydrocarbon oil may be, for example, an oil originating from heavy gas oil. By using such a hydrocarbon oil, a required amount of wax can be secured at low cost. The precipitation step is carried out in the absence of a solvent, from the viewpoint of reducing the energy required for cooling by raising the precipitation temperature, or from the viewpoint of simplifying a step by omitting a separation step from a mixed solvent.

The hydrocarbon oil contains normal paraffin. The content ratio of normal paraffin in the hydrocarbon oil is not particularly limited; however, for example, the content ratio may be 5% by volume or more and is preferably 7% by volume or more, and more preferably 10% by volume or more. The content ratio of normal paraffin in the hydrocarbon oil may be, for example, 20% by volume or less and is preferably 17% by volume or less, and more preferably 15% by volume or less.

With regard to the hydrocarbon oil, the average number of carbon atoms of the normal paraffin is preferably 23 or more, and more preferably 25 or more. With regard to the hydrocarbon oil, the average number of carbon atoms of the normal paraffin is preferably 28 or less, and more preferably 27 or less.

With regard to the hydrocarbon oil, the content ratio of normal paraffin having 20 or more carbon atoms is not particularly limited; however, for example, the content ratio may be 7% by volume or more and is preferably 8% by volume or more, and more preferably 9% by volume or more. With regard to the hydrocarbon oil, the content ratio of normal paraffin having 25 or more carbon atoms may be, for example, 3% by volume or more and is preferably 4% by volume or more, and more preferably 5% by volume or more.

The hydrocarbon oil may further contain other hydrocarbon compounds other than normal paraffin. Examples of the other hydrocarbon compounds include isoparaffin, cycloparaffin, and aromatic fractions.

Examples of the low-temperature fluidity improver include an ethylene-vinyl acetate copolymer, a polyalkyl methacrylate, an alkenyl succinic acid imide, a polyalkylene oxide fatty acid ester, a polyalkyl acrylate, an alkyl naphthalene, an olefin copolymer, a styrene-diene copolymer, and a dendrimer. Among these, from the viewpoint of precipitating a wax fraction having a small oil content, and increasing the yield in the separation step, an ethylene-vinyl acetate copolymer, a polyalkyl methacrylate, and a polyalkylene oxide fatty acid ester (all low-temperature fluidity improvers for gas oil) are preferred, and an ethylene-vinyl acetate copolymer is more preferred. These may be used singly, or two or more kinds thereof may be used as a mixture.

In the case of using an ethylene-vinyl acetate copolymer, the number average molecular weight (Mn) is preferably 6,000 or less, more preferably 1,000 to 5,000, and even more preferably 2,000 to 4,000, from the viewpoint of the precipitation temperature. The vinyl acetate percentage content (VA) in the ethylene-vinyl acetate copolymer is preferably 20% by mass or more, more preferably 25% to 60% by mass, and even more preferably 30% to 45% by mass, from the viewpoint of reducing wax growth.

The number average molecular weight (Mn) can be determined by Japanese Industrial Standards (JIS) K7252 (Plastics-Determination of average molecular mass and molecular mass distribution of polymers using size-exclusion chromatography-). The vinyl acetate percentage content (VA) can be determined by Japanese Industrial Standards (JIS) K7192 (Plastics-Ethylene/vinyl acetate copolymer (EVAC) thermoplastics-Determination of vinyl acetate content).

The amount of addition of the low-temperature fluidity improver with respect to the hydrocarbon oil is preferably 0.01 parts by mass or more, and more preferably 0.025 parts by mass or more, with respect to 100 parts by mass of the hydrocarbon oil, from the viewpoint of increasing the wax recovery ratio and improving the fluidity of the hydrocarbon oil. From the viewpoint of lowering the concentration of impurities other than the normal paraffin in the wax thus obtained, the amount of addition is preferably 0.06 parts by mass or less, and more preferably 0.05 parts by mass or less, with respect to 100 parts by mass of the hydrocarbon oil.

The pour point of a mixed oil (before precipitating a solid material) obtainable by adding a low-temperature fluidity improver to a hydrocarbon oil is preferably 20° C. or lower, and more preferably 15° C. or lower, from the viewpoint of filterability. The lower limit of this pour point is not particularly limited; however, for example, the lower limit can be set to −5° C. The pour point can be determined by Japanese Industrial Standards (JIS) K2269 (Testing Methods for Pour Point and Cloud Point of Crude Oil and Petroleum Products).

After a low-temperature fluidity improver is added to a hydrocarbon oil, a solid material is precipitated out from the mixed oil by leaving the mixed oil under the temperature conditions of 5° C. to 40° C. When the solid material is precipitated out, if necessary, stirring by means of a mixer, a glass rod, or the like may also be carried out. The temperature conditions are more preferably 15° C. to 25° C., from the viewpoints of maintaining the fluidity of the hydrocarbon oil and reducing the fluctuations in the particle size distribution of the solid material thus precipitated. The particle size distribution can be determined by Japanese Industrial Standards (JIS) Z8825 (Particle size analysis-Laser diffraction methods), or the like.

The solid material that has been precipitated out in the hydrocarbon oil by the precipitation step is collected as a non-transmissive fraction by a solid-liquid separation method.

Regarding the solid-liquid separation method, a method of performing solid-liquid separation by filtration using a solid-liquid separation membrane having a pore size of 2 μm or more under the temperature conditions of higher than 0° C., or centrifugal separation, may be mentioned. In the case of the former, a cloth, a mesh, a packed bed, a porous material, and the like can be used as the filter material, and the solid material can be separated by filter pressing, gravity filtration, pressure filtration, vacuum filtration, centrifugal filtration, or the like. Regarding the material constituting the cloth, synthetic fibers, natural fibers, glass fibers, and the like can be used, and specific examples include polypropylene, polyester, polyamide, and cotton cloth. As the mesh, a metal mesh can be used, and specific examples of the constituent material include carbon steel, stainless steel, monel metal, nickel, and aluminum. As the material that constitutes the packed bed, sand, white clay, activated carbon, and the like can be used. As the porous material, separation membranes including a sintered metal, porous graphite, an inorganic membrane (membrane formed of an inorganic material), and the like can be used, and specific examples include separation membranes including a stainless steel sintered body, a silica membrane, an alumina membrane, a zeolite membrane, and the like; and a glass filter. The pore size may be measured by a physical measurement method such as an optical microscope, or may be measured using the retention particle size (a particle size at which 90% or more can be retained when a dispersed water of seven kinds of powders specified in Japanese Industrial Standards (JIS) Z8901 is subjected to natural filtration). In the case of the latter, the solid material can be separated using separators of a separation plate type, a cylinder type, a decanter type, and the like.

The content of the low-temperature fluidity improver that is included in the wax is not particularly limited because the content may vary depending on the initial amount of addition and the production process; however, the content can be adjusted to 0.01% to 5% by mass. The content may be 0.03% to 3% by mass or may be 0.05% to 1% by mass.

The content of the low-temperature fluidity improver that is included in the wax can be measured by Fourier transform infrared spectroscopy (FT-IR) or a double shot method combining thermal desorption (TD)-GC/MS in a first stage and instantaneous pyrolysis (Py)-GC/MS in a second stage.

Thus, an example of the method for producing an unrefined wax has been described.

The solvent used for the method for producing a paraffin wax according to the present embodiment has specific HSP. The HSP are physical property values possessed by a certain substance, the physical property values being represented by a dispersion term (δd), which is the energy based on the dispersion forces between molecules; a dipole term (δp), which is the energy based on dipolar interaction between molecules; and a hydrogen bonding term (δh), which is the energy based on hydrogen bonding between molecules. It is known that substances having similar HSP exhibit similar physical properties. According to the findings of the inventors, among these three parameters, it is understood that particularly the dipole term (δp) and the hydrogen bonding term (δh) are important for the present step.

From the viewpoint of obtaining a high washing effect (effect of increasing the normal paraffin concentration in the wax) with a small amount of a solvent, the dipole term (δp) for the above-described solvent is 4 to 8, and the hydrogen bonding term (δh) is 3 to 10. The dipole term (δp) is preferably 6 to 8, and more preferably 7 to 8. The hydrogen bonding term (δh) is preferably 5 to 9, and more preferably 5 to 7. The dispersion term (δd) is not particularly limited; however, the dispersion term can be set to 3 to 18.

A solvent having the above-described HSP can be obtained by appropriately combining known solvents. Among known solvents, from the viewpoint of not being the poisonous substances or deleterious substances specified by the Poisonous and Deleterious Substances Control Law in Japan, and from the viewpoint of reducing the heat of evaporation of the solvent to a low level, for example, ethanol, acetone, normal hexane, methylcyclopentane, and the like can be mentioned as suitable solvents. Solvents obtainable by combining these solvents do not include the poisonous substances or deleterious substances specified by the Poisonous and Deleterious Substances Control Law in Japan, such as methyl ethyl ketone and toluene. The phrase “not including poisonous substances or deleterious substances” implies that in an analysis performed using a gas chromatography device comprising an FID detector, the concentration of poisonous substances and deleterious substances is less than or equal to the detection limit concentration (1 ppm or less).

Regarding the solvent having the above-described HSP, from the viewpoint of reducing the heat of evaporation to a low level, it is preferable to use a mixed solvent including acetone. Specifically, acetone, normal hexane, methylcyclopentane, solvents obtained by arbitrarily mixing these, and the like are preferred. From the viewpoint of the separation factor that will be described below and the recovery ratio of normal paraffin, the content of acetone in the mixed solvent may be 50% by volume or more and is preferably more than 50% by volume, more preferably 60% by volume or more, and even more preferably 75% by volume or more.

From the viewpoints of cost and environmental load, it is practical to use the solvent repeatedly. For example, from the solvent in which impurities (for example, other hydrocarbon compounds other than normal paraffin, and the like) are dissolved after the separation step, the solvent can be recovered by distillation. In this recovering step, since evaporation and condensation of the solvent is repeated, it is preferable that the heat of evaporation of the solvent is lower. From this point of view, the heat of evaporation of the solvent may be 500 kJ/L or less, is preferably 450 kJ/L or less, and more preferably 400 kJ/L or less. The lower limit of the heat of evaporation is not particularly limited; however, for example, the lower limit may be 100 kJ/L. The heat of evaporation of the solvent can be measured using a differential scanning calorimeter.

The mixing ratio of the unrefined wax and the solvent is not particularly limited; however, mixing may be carried out such that the mass ratio of the solvent with respect to the unrefined wax (mass of the solvent/mass of the unrefined wax) is 5/1 to 1/2. Thereby, a high washing effect for the unrefined wax is easily maintained while reducing the amount of use of the solvent. When the amount of use of the solvent is small, the wax that is dissolved in the solvent and lost can be reduced. From this point of view, the above-described mass ratio is preferably 3/1 to 1/2, more preferably 2/1 to 1/2, and even more preferably 1/1 to 1/2.

(Separation Step)

Regarding the method of separating a solid material from a mixed liquid of unrefined wax and a solvent, for example, a solid-liquid separation method may be mentioned. Regarding the solid-liquid separation method, specifically, filtration using a solid-liquid separation membrane, or centrifugal separation may be mentioned, and the details thereof are as described above in the section for the method for producing an unrefined wax. The liquid temperature of the mixed liquid at the time of being subjected to the separation step can be adjusted to −10° C. to 20° C.

According to the present production method, a paraffin wax from which preferably 80% by volume or more of components other than normal paraffin included in unrefined wax has been removed, can be obtained.

According to the present production method, the separation factor calculated by the following formula may be 5 or greater and is preferably 5.5 or greater, and more preferably 6 or greater. The upper limit of the separation factor is not particularly limited; however, for example, the upper limit may be 10.

(Cw/(1−Cw))/(C0/(1−C0))

wherein Cw and C0 represent the normal paraffin concentration in the paraffin wax (refined wax) and the normal paraffin concentration in the unrefined wax, respectively.

The content of normal paraffin in the solid material (that is, refined wax) also depends on the normal paraffin concentration in the unrefined wax, which is a raw material, and is therefore not particularly limited; however, for example, the content may be 50% by volume or more and is preferably 60% by volume or more, and more preferably 80% by volume or more. The upper limit of this content is not particularly limited; however, for example, the upper limit may be 95% by volume or less.

(Solvent Selection Step)

The present step can be carried out prior to the mixing step. As described above, a solvent having desired HSP can be obtained by appropriately combining known solvents. The HSP of a solvent can be calculated using a computer software program or the like, and when known values are available, those can be used. In the present step, a highly safe solvent that is appropriate for the washing of unrefined wax can be freely prepared by paying attention to the HSP of solvents.

### EXAMPLES

Hereinafter, the present invention will be described more specifically by way of Examples; however, the present invention is not intended to be limited to the Examples.

<Production of Paraffin Wax>

### Example 1

300 g of a hydrocarbon oil of 10 vol % distillation temperature is 324.9° C., of 90 vol % distillation temperature is 432.0° C., and of pour point is 22.5° C., was transferred into a 500-mL borosilicate glass beaker (manufactured by Corning Incorporated). On the other hand, 0.09 g of an ethylene-vinyl acetate copolymer-based low-temperature fluidity improver for gas oil, MD336K (manufactured by Sanyo Chemical Industries, Ltd.: Mn 4,000, VA 38% by mass) was introduced into a 200-mL screw tube (manufactured by Maruemu Corporation), and this was heated in a water bath (manufactured by AS ONE Corporation) for one hour at 60° C. The low-temperature fluidity improver for gas oil prepared as such was added to the hydrocarbon oil, the mixture was stirred with a glass rod and mixed, and thus a mixed oil was obtained. The pour point of the mixed oil was 4° C.

Next, 45 g of this mixed oil was introduced into a 100-mL screw tube (manufactured by Maruemu Corporation), and this was left to stand for 10 minutes in a low-temperature constant temperature water bath (manufactured by AS ONE Corporation) set at 15° C. The mixed oil after standing was subjected to vacuum filtration using a vacuum filter KGS-47 equipped with a glass filter grade GF/D Paraffin (manufactured by Whatman plc, retention particle size: 2.7 μm), and a suction flask VT-500 (all manufactured by ADVANTEC). The filtering conditions were set to a vacuum side pressure of −0.95 MPa, a filtering temperature of 15° C., and a filtering time of 20 minutes. By vacuum filtration, 3 g of a solid material (unrefined wax) on the glass filter and a filtrate (hydrocarbon oil) having a pour point of 5° C. were obtained. The normal paraffin concentration in this solid material was 45% by volume.

Next, a solvent obtained by mixing acetone and normal hexane at 3:1 (volume ratio) was prepared as the solvent. The HSP and the heat of evaporation of the solvent are presented in Table 1. The HSP of the solvent were determined using a software program HSPiP (Hansen Solubility Parameters in Practice: software for Windows (registered trademark) for efficiently handling HSP) developed by Hansen and colleagues. This software HSPiP can be obtained from http://www.hansen-solubility.com/, currently as of Oct. 1, 2019. Also, in the case of a mixed solvent in which a plurality of solvents is mixed, and the like, the HSP (δd, δp, and δh) can be calculated.

The unrefined wax and solvent obtained as described above were weighed such that the mass ratio would be 1:1, the substances were accommodated in a 50-mL screw tube, subsequently the mixture was thoroughly shaken, and thereby a slurry was obtained.

This slurry was left to stand for 10 minutes in a low-temperature constant temperature bath (manufactured by AS ONE Corporation) set at 10° C. The slurry after standing was subjected to vacuum filtration using a vacuum filter KGS-47 equipped with a Kiriyama filter paper No. 5A, and a suction flask VT-500. The filtering conditions were set to a vacuum side pressure of −0.95 MPa, a filtering temperature of 10° C., and a filtering time of 2 minutes. By vacuum filtration, a solid material (refined wax) on the Kiriyama filter paper and a filtrate were obtained. The normal paraffin concentration in this solid material (refined wax) was 83% by volume. The normal paraffin concentration in the dissolved component except for the solvent in the filtrate separated from the refined wax was 8% by volume.

### OTHER EXAMPLES AND COMPARATIVE EXAMPLES

Solid materials (refined waxes) were obtained in the same manner as in Example 1, except that the above-described solvent was changed to the solvents indicated in Table 1.

TABLE 1

| | Solvent | | | | | |
|---|---|---|---|---|---|---|
| | | | | | Heat of | |
| | Composition | HSP | | | evaporation | |
| | (volume ratio) | δd | δp | δh | (kJ/L) | Remarks |
| Example 1 | Acetone/n-hexane | 15.4 | 7.8 | 5.3 | 351 | — |
| | (75/25) | | | | | |
| Example 2 | Acetone/n-hexane | 15.3 | 6.2 | 4.2 | 325 | — |
| | (60/40) | | | | | |
| Example 3 | Acetone/n-hexane | 15.2 | 5.2 | 3.5 | 307 | — |
| | (50/50) | | | | | |
| Example 4 | Ethanol/n-hexane | 15.4 | 4.4 | 9.7 | 440 | — |
| | (50/50) | | | | | |
| Example 5 | Acetone/n-hexane/ | 15.3 | 7.8 | 5.4 | 375 | — |
| | methylcyclopentane | | | | | |
| | (75/15/10) | | | | | |
| Comparative | Acetone | 15.5 | 10.4 | 7 | 395 | — |
| Example 1 | | | | | | |
| Comparative | n-Hexane | 14.9 | 0 | 0 | 219 | — |
| Example 2 | | | | | | |
| Comparative | Acetone/n-hexane | 15.1 | 4.2 | 2.8 | 290 | — |
| Example 3 | (40/60) | | | | | |
| Comparative | Acetone/n-hexane | 15.1 | 2.6 | 1.8 | 263 | — |
| Example 4 | (25/75) | | | | | |
| Comparative | Ethanol | 15.8 | 8.8 | 19.4 | 661 | — |
| Example 5 | | | | | | |
| Comparative | MEK/toluene | 17.5 | 3.3 | 2.8 | 325 | Deleterious |
| Example 6 | (25/75) | | | | | substance |

<Evaluation>

(Separation factor)

The separation factor was calculated by the following formula. The results are presented in Table 2.

(Cw/(1−Cw))/(C0/(1−C0))

Provided that Cw and C0 represent the normal paraffin concentrations in the wax after washing (refined wax) and the wax before washing (unrefined wax), respectively.

(Normal Paraffin Recovery Ratio)

The normal paraffin recovery ratio was calculated by the following formula. The results are presented in Table 2.

(Amount of normal paraffin included in refined wax/amount of normal paraffin included in unrefined wax)×100 (%)

TABLE 2

| | | Normal paraffin | Normal paraffin |
|---|---|---|---|
| | Separation | recovery | concentration |
| | factor | ratio (%) | in wax (vol %) |
| Example 1 | 6.1 | 91 | 83 |
| Example 2 | 6.8 | 85 | 85 |
| Example 3 | 6.2 | 86 | 84 |
| Example 4 | 6.5 | 85 | 84 |
| Example 5 | 6.1 | 89 | 83 |
| Comparative | 1.5 | 98 | 55 |
| Example 1 | | | |
| Comparative | 8.1 | 67 | 87 |
| Example 2 | | | |
| Comparative | 7.4 | 79 | 86 |
| Example 3 | | | |
| Comparative | 7.4 | 75 | 86 |
| Example 4 | | | |
| Comparative | 1.2 | 98 | 49 |
| Example 5 | | | |
| Comparative | 7.2 | 83 | 85 |
| Example 6 | | | |

In the Examples, excellent separation factors and normal paraffin recovery ratios could all be achieved. The results were excellent results comparable to the case of using methyl ethyl ketone and toluene, which are specified as deleterious substances (Comparative Example 6).

1. A method for producing a paraffin wax, the method comprising:
mixing an unrefined wax including normal paraffin with a solvent of dipole term (δp) is 4 to 8 and of hydrogen bonding term (δh) is 3 to 10 of the Hansen Solubility Parameters, and obtaining a mixed liquid; and
separating a solid material from the mixed liquid and obtaining a paraffin wax in which a normal paraffin concentration is higher.

2. The method according to claim 1, wherein the solvent does not include a poisonous substance or a deleterious substance, which are specified by the Poisonous and Deleterious Substances Control Law in Japan.

3. The method according to claim 1, wherein a heat of evaporation of the solvent is 500 kJ/L or less.

4. The method according to claim 1, wherein the unrefined wax and the solvent are mixed such that a mass ratio of the solvent with respect to the unrefined wax (mass of the solvent/mass of the unrefined wax) is 5/1 to 1/2.

5. The method according to claim 1, wherein a separation factor calculated by the following formula is 5 or greater:
(Cw/(1−Cw))/(C0/(1−C0))
wherein Cw and C0 represent the normal paraffin concentration in the paraffin wax and the normal paraffin concentration in the unrefined wax, respectively.

6. The method according to claim 1, further comprising a step of selecting a solvent of dipole term (δp) is 4 to 8 and of hydrogen bonding term (δh) is 3 to 10 of the Hansen Solubility Parameters.
